(19) United States
(12) Patent Application Publication
(10) Pub. No.: US 2017/0297422 A1
(43) Pub. Date: Oct. 19, 2017

(54) Variable Inertia Flywheel

(71) Applicant: Dana Limited, Maumee, OH (US)

(72) Inventors: Maximilian Hombsch, Ghent (BE); Mark RJ Versteyhe, Oostkamp (BE)

(21) Appl. No.: 15/642,254

(22) Filed: Jul. 5, 2017

Related U.S. Application Data
(63) Continuation-in-part of application No. 14/204,610, filed on Mar. 11, 2014.
(60) Provisional application No. 61/777,281, filed on Mar. 12, 2013.

(51) Int. Cl. B60K 6/10; F16F 15/31; F16F 15/30; F16F 15/00

(52) U.S. Cl. CPC B60K 6/105; F16F 15/31; F16F 15/30; F16F 15/00; B60K 6/10

(57) ABSTRACT

A variable inertia flywheel having revolute joint assemblies, a roller guide, a first actuator and a second actuator. The revolute joint assemblies are in engagement with a primary mover and include a first member, a second member and a roller. The roller guide is disposed about the revolute joint assemblies. An inner surface of the roller guide is in contact with the rollers and defines cam profiles that cause the rollers to extend and contract, creating a torque disturbance opposed to a primary mover torque ripple. The first actuator is in engagement with the roller guide and moves the roller guide, changing the amplitude and/or the phase angle of the torque ripple. The second actuator is in engagement with the roller guide and rotates the roller guide, changing the phase angle of the torque ripple.

### RELATED APPLICATIONS

The present application is a continuation-in-part application of U.S. patent application Ser. No. 14/204,610 filed on Mar. 11, 2014 which claims the benefit of U.S. Provisional Application No. 61/777,281 filed on Mar. 12, 2013, which are incorporated herein in their entirety by reference.

### FIELD

The present disclosure relates to internal combustion engines and more specifically to a variable inertia flywheel for use with an internal combustion engine.

### BACKGROUND

Due to recent improvements in combustion engine technology, there has been a trend to downsize internal combustion engines used in vehicles. Such improvements also result in more efficient vehicle, while maintaining similar performance characteristics and vehicle form factors favoured by consumers

One common improvement used with internal combustion engines is the addition of a supercharger or a turbocharger. Typically, the addition of the supercharger or the turbocharger is used to increase a performance of an engine that has been decreased in displacement or a number of engine cylinders. Such improvements typically result in an increased torque potential of the engine, enabling the use of longer gear ratios in a transmission of the vehicle. The longer gear ratios in the transmission enable a down-speeding of the engine. Engine down-speeding is a practice of operating the engine at lower operating speeds. Such improvements typically result in improved fuel economy, operation near their most efficient level for a greater amount of time compared to conventional engines, and reduced engine emissions.

In some designs, however, engine down-speeding can result in an undesirable increase in torque ripple at low operating speeds of the engine. For example, a significantly increased torque ripple can appear at an engine output when the engine is operating at low idle speeds. The torque ripple is a well-known engine dynamic that results from torque not being delivered constantly, but periodically during each power stroke of the operating cycle of an internal combustion engine. FIG. 1 is a graph illustrating a torque output of an engine during a four-stroke cycle of an engine. In the four-stroke cycle, the torque ripple happens once every two turns of a crankshaft for each cylinder of the engine. Accordingly, a four cylinder engine will have two torque ripples per crankshaft turn while a three cylinder engine will have three ripples every two crankshaft turns.

An amplitude of the torque ripple also varies with an operating speed of the engine and a load applied to the engine. A phase of the torque ripple varies with an operating speed and a load applied to the engine. Torque ripples can cause many problems for components of the vehicle near the engine, such as but not limited to: increased stress on the components, increased wear on the components, and exposure of the components to severe vibrations. These problems can damage a powertrain of the vehicle and result in poor drivability of the vehicle. In order to reduce the effects of these problems, smooth an operation of the engine, and improve an overall performance of the engine, the torque ripples may be compensated for using an engine balancing method. Many known solutions are available for multi-cylinder engine configurations to reduce or eliminate the stresses and vibration caused by the torque ripples.

Torque ripple compensator devices are known in the art; however, the known device have many shortcomings. In many conventional vehicles, the torque ripples are compensated for using at least one flywheel. FIG. 2 illustrates a conventional flywheel based damping system. In other applications, a dual-mass flywheel system may be used. An inertia of the flywheel dampens a rotational movement of the crankshaft, which facilitates operation of the engine running at a substantially constant speed. Flywheels may also be used in combination with other dampers and absorbers.

A weight of the flywheel, however, can become a factor in such torque ripple compensating devices. A lighter flywheel accelerates faster but also loses speed quicker, while a heavier flywheel retain speeds better compared to the lighter flywheel, but the heavier flywheel is more difficult to slow down. However, a heavier flywheel provides a smoother power delivery, but makes an associated engine less responsive, and an ability to precisely control an operating speed of the engine is reduced.

The main torque ripple occurs at the second order. Dual mass centrifugal pendulums with an internal cam profile are known devices that generate an opposite second order torque ripple to cancel out the second order main torque ripple. These devices, and their limitations, are further described below.

Dual mass centrifugal pendulum devices are known in the art. A rotating mass of a portion of the known dual mass centrifugal pendulum devices generates centrifugal forces. The centrifugal forces result in a generated torque, which is applied to an engine output shaft to counteract the torque ripples generated by the engine. The cammed surface is typically a non-circular profile which generates a variable torque on the engine output shaft as the rollers move radially inwardly and outwardly from the engine output shaft by following a shape of the cammed surface.

In addition to an increased weight of such devices, a fundamental problem of known variable inertia and damping systems is a lack of adaptability. Such devices are designed for a worst operational case and must have enough mass to damp vibrations at lower operational speeds. As a result, known devices are typically designed for higher operational speeds and have a tendency to inhibit vehicle performance and reduce a reactivity of the engine.

Known variable inertia and damping systems which compensate for amplitude of torque ripples do not compensate for a changing phase of the torque ripples generated by the engine. A phase of the torque ripples also varies based on a rotational speed of the engine and a load applied to the engine.

It would be advantageous to develop a variable inertia flywheel able to be dynamically adapted for both an amplitude and a phase of a torque ripple while minimizing an interference with an operation of an internal combustion engine.

### SUMMARY

Provided herein is a variable inertia flywheel able to be dynamically adapted for both an amplitude and a phase of a torque ripple while minimizing an interference with an operation of an internal combustion engine.

Provided herein is a variable inertia flywheel for a primary mover; the variable inertia flywheel having a central shaft defining a primary axis and in driving engagement with the primary mover and a transmission, a flywheel housing coupled to the primary mover and the transmission, at least two revolute joint assemblies, a roller guide, a first actuator and a second actuator. The revolute joint assemblies are in driving engagement with the central shaft and include a first member coupled to the central shaft, a second member pivotally coupled to the first member, and a roller rotatably coupled to the second member. The roller guide is disposed about the revolute joint assemblies and the central shaft and has a substantially hollow conical shape and a radially inner surface. The radially inner surface defines at least two cam profiles and is in rolling contact with each of the rollers of the revolute joint assemblies. In one embodiment, the first actuator is in engagement with the roller guide and is configured to apply a force to the roller guide to move the roller guide linearly in the direction of the primary axis. The second actuator is in engagement with the roller guide and is configured to apply a force to the roller guide to rotate the roller guide.

Provided herein is a variable inertia flywheel for a primary mover; the variable inertia flywheel having a central shaft defining a primary axis and in driving engagement with the primary mover and a transmission, a flywheel housing coupled to the primary mover and the transmission, at least two revolute joint assemblies, a roller guide and an actuator. The revolute joint assemblies are in driving engagement with the central shaft and include a first member coupled to the central shaft, a second member pivotally coupled to the first member, and a roller rotatably coupled to the second member. The roller guide is disposed about the revolute joint assemblies and the central shaft and has a substantially hollow cylindrical or conical shape and a radially inner surface. The radially inner surface defines at least two cam profiles and in rolling contact with each of the rollers of the revolute joint assemblies. In one embodiment, the actuator is in engagement with the roller guide and is configured to apply a force to the roller guide to move the roller guide along the primary axis. The angular position of the cam profiles on the radially inner surface of the roller guide varies with respect to the primary axis.

Various aspects of this invention will become apparent to those skilled in the art from the following detailed description of the preferred embodiment, when read in light of the accompanying drawings.

### BRIEF DESCRIPTION OF THE DRAWINGS

The above, as well as other advantages of the present invention will become readily apparent to those skilled in the art from the following detailed description when considered in the light of the accompanying drawings in which:

FIG. 1 is a a graph illustrating a torque output of an engine during a four stroke cycle of an engine;

FIG. 2 is a sectional view of a flywheel based damping system known in the prior art;

FIG. 3A is a schematic illustration of a variable inertia flywheel according to a preferred embodiment;

FIG. 3B is a sectional view of the variable inertia flywheel shown in FIG. 3A with the position of the section indicated by a dash-dot line marked with A-A within FIG. 3A;

FIG. 3C is a schematic illustration of the variable inertial flywheel shown in FIG. 3A showing the roller guide moved along the axis;

FIG. 4A is a schematic illustration of a variable inertia flywheel according to another preferred embodiment;

FIG. 4B is a sectional view of the variable inertia flywheel shown in FIG. 4A with the position of the section indicated by a dash-dot line marked with B-B within FIG. 4A;

FIG. 4C is a schematic illustration of the variable inertial flywheel shown in FIG. 4A showing the roller guide moved along the axis;

FIG. 5A is a schematic illustration of a variable inertia flywheel according to another preferred embodiment;

FIG. 5B is a sectional view of the variable inertia flywheel shown in FIG. 5A with the position of the section indicated by a dash-dot line marked with C-C within FIG. 5A;

FIG. 6A is a schematic illustration of a variable inertia flywheel according to another preferred embodiment;

FIG. 6B is a sectional view of the variable inertia flywheel shown in FIG. 6A with the position of the section indicated by a dash-dot line marked with D-D within FIG. 6A; and

FIG. 6C is a sectional view of the variable inertia flywheel shown in FIG. 6A with the position of the section indicated by a dash-dot line marked with E-E within FIG. 6A.

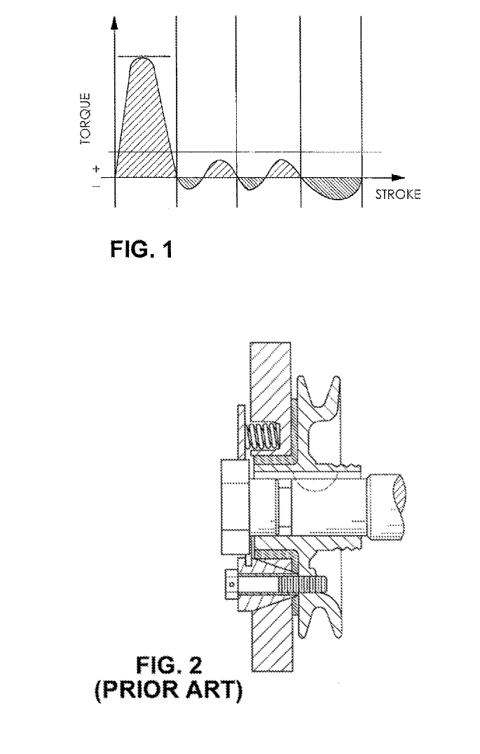

### DETAILED DESCRIPTION OF THE PREFERRED EMBODIMENTS

It is to be understood that the invention may assume various alternative orientations and step sequences, except where expressly specified to the contrary. It is also to be understood that the specific devices and processes illustrated in the attached drawings, and described in the following specification are simply exemplary embodiments of the inventive concepts defined herein. Hence, specific dimensions, directions or other physical characteristics relating to the embodiments disclosed are not to be considered as limiting, unless expressly stated otherwise.

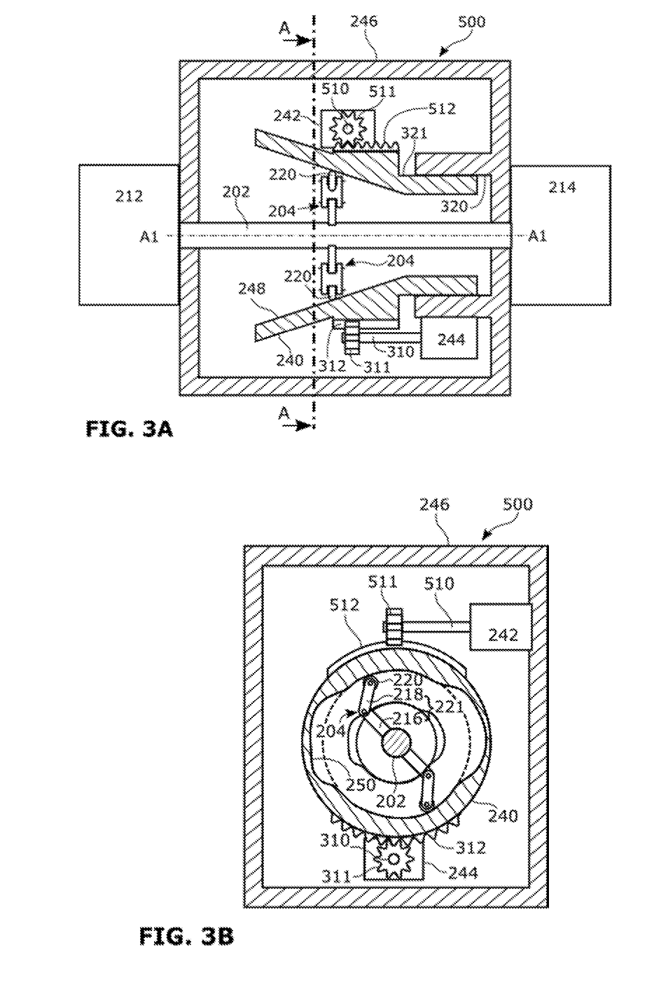

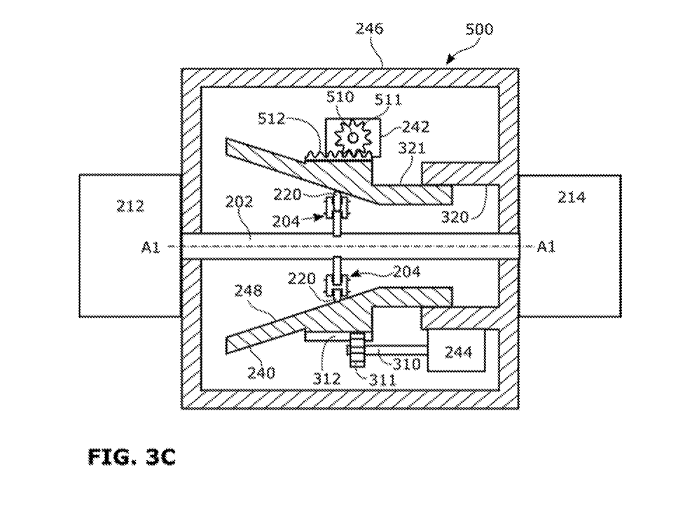

FIGS. 3A-3C illustrate one preferred embodiment of a variable inertia flywheel 500. The variable inertia flywheel 500 includes a central shaft 202, at least two revolute joint assemblies 221, a roller guide 240, a first actuator 242, a second actuator 244 and a flywheel housing 246. The central shaft 202 is in driving engagement with a primary mover 212 and a transmission 214. The primary mover 212 may be an internal combustion engine, an electric engine, a hydraulic motor or pneumatic motor, a gas or liquid driven motor or a combination of the mentioned devices. The central shaft 202 defines a primary axis A1 of the variable inertia flywheel 500. The at least two revolute joint assemblies 221 are in driving engagement with the central shaft 202. A portion of each of the revolute joint assemblies 221 is in rolling contact with the roller guide 240. The roller guide 240 is a hollow rigid member disposed within the flywheel housing 246 and disposed about the central shaft 202 and the revolute joint assemblies 221.

In some embodiments, the roller guide 240 is fixed in the radial direction by a first cylindrical sliding surface 321 on the radially outer surface of the roller guide 240 and in sliding contact with a second sliding surface 320 on the radially inner surface of a portion of the flywheel housing 246. The sliding surfaces 321, 320 allow the roller guide 240 to move axially along the primary axis A1 as well as to rotate around the primary axis A1, while limiting the rotational and translational movement of the roller guide 240 perpendicular to the primary axis A1. The first actuator 242 can be, but is not limited to, a stepper motor, a servomotor, a hydraulic motor a pneumatic motor, or any kind of known actuator. In some embodiments, the first actuator 242 includes an internal down-speeding gearset (not shown). The first actuator 242 is rigidly connected to the flywheel housing 246 and drives a first actuator shaft 510, which is aligned perpendicular to the primary axis A1 and drivingly connected to a first actuator gear 511. The first actuator gear 511 includes a set of teeth thereon meshingly engaged with a plurality of teeth positioned on the outer radial surface of the roller guide 240.

The second actuator 244 can be, but is not limited to, a stepper motor, a servomotor, a hydraulic motor a pneumatic motor, or any kind of known actuator. In some embodiments, the second actuator 244 includes an internal down-speeding gearset (not shown). The second actuator 244 is rigidly connected to the flywheel housing 246 and drives a second actuator shaft 310, which is aligned parallel to the primary axis A1 and drivingly connected to a second actuator gear 311. The second actuator gear 311 includes a set of teeth thereon meshingly engaged with a plurality of teeth positioned on the radially outer surface of the roller guide surface 240.

The flywheel housing 246 is disposed about the roller guide 240, the first actuator 242 and the second actuator 244. The flywheel housing 246 is rigidly coupled to at least one of the primary mover 212 and the transmission 214. The central shaft 202 may form a portion of one of the primary mover 212 and the transmission 214, or the central shaft 202 may be formed separate therefrom. In some embodiments, the central shaft 202 is in driving engagement with primary mover 212 and the transmission 214 through splined connections (not shown) formed on each end thereof; alternately, it is understood that the central shaft 202 may be in driving engagement with the primary mover 212 and the transmission 214 in any other conventional manner.

The revolute joint assemblies 221 include at least a first member 216, a second member 218, and a roller 220. Each of the revolute joint assemblies 221 extends radially outward from the central shaft 202. As shown in FIGS. 3A-3C, the variable inertia flywheel 500 includes two revolute joint assemblies 221 opposingly disposed on the central shaft 202. In some embodiments, the first member 216 is a rigid member coupled to the central shaft 202 at a first end thereof. In some embodiments, the first member 216 may be pivotally coupled to the central shaft 202. In some embodiments, the first member 216 is pivotally coupled to the second member 218 at a second end thereof using a joint 204 that allows movement around an axis parallel to the primary axis A1. In some embodiments, a biasing member (not shown) is disposed between the first member 216 and the second member 218 to urge the second member 218 away from the first member 216. The second member 218 is rotatably coupled to the roller 220 at one end thereof, opposite the first member 216. In some embodiments, the roller 220 is a ball or disk shaped member which is rotatably coupled to the second member 218. Alternately, the roller 220 may have other shapes. The roller 220 is configured to rotate about an axis substantially parallel to the primary axis A1. When the variable inertia flywheel 500 is assembled, the roller 220 is in rolling contact with a radially inner surface 248 of the roller guide 240.

As shown in FIGS. 3A and 3B, in some embodiments, the roller guide 240 is a substantially hollow conical shaped member, but it is understood that the roller guide 240 may have other shapes, including a substantially cylindrical shape. The radially inner surface 248 of the roller guide 240, which in some embodiments is a generally conical shaped surface, defines at least two cam profiles 250. In some embodiments, the number of cam profiles 250 can vary and corresponds to the number of the revolute joint assemblies 221.

In response to a force applied to the roller guide 240 by the first actuator 242, the roller guide 240 moves linearly along the primary axis A1. In response to a force applied to the roller guide 240 by the second actuator 244, the roller guide 240 rotates around the primary axis A1. In some embodiments, the cam profiles 250 are elongate recesses defined by the inner surface 248 of the roller guide 240. In some embodiments, the shape of each of the cam profiles 250 can deviate from the inner surface 248, which is a generally conical shaped surface, of the roller guide 240. As shown in FIGS. 3A and 3B, in some embodiments, the cam profiles 250 extend radially outwardly from the inner surface 248 and have a generally “U” shaped cross-section. However, it is understood that the cam profiles 250 may have other shapes. In some embodiments, the cam profiles 250 extend substantially along the entire length of the inner surface 248 of the roller guide 240; however, it is understood that the cam profiles 250 may only extend along a partial length of the inner surface 248. Further, the cam profiles 250 may vary in cross-sectional shape along the length of the inner surface 248. In some embodiments, the cam profiles 250 have similar shapes and are opposingly oriented about the inner surface 248. The inner surface 248 may also define a plurality of cam profiles 250, separate from one another.

In response to a control signal from a controller (not shown), the first actuator 242 applies a force to the roller guide 240 to move the roller guide 240 axially along the primary axis A1, changing the position of the revolute joint assemblies 221 with respect to the roller guide 240. It is also understood that the first actuator 242 may be a passive guide actuator, including at least one biasing member to control a position of the roller guide 240.

Additionally, in response to a control signal from a controller (not shown), the second actuator 244 applies a force to the roller guide 240 to rotate the roller guide 240 around the primary axis A1, changing the angle of the revolute joint assemblies 221 with respect to the cam profiles 250. It is also understood that the second actuator 244 may be a passive guide actuator, including at least one biasing member to control a position of the roller guide 240.

The flywheel housing 246 is a hollow rigid body into which the central shaft 202, the at least two revolute joint assemblies 221, the roller guide 240, the first actuator 242 and the second actuator 244 are disposed in. In some embodiments, the flywheel housing 246 is substantially fixed with respect to the primary mover 212. As a non-limiting example, the flywheel housing 246 is a housing removably coupled to the primary mover 212 and the transmission 214; however, it is understood that the flywheel housing 246 may be another rigid body coupled to a portion of a vehicle (not shown) incorporating the variable inertia flywheel 500.

In some embodiments, the primary mover 212 applies power to the central shaft 202 through a crankshaft (not shown). In some embodiments, the primary mover 212, is a four-cycle internal combustion engine; however, it is understood that the primary mover 212 may be another type of internal combustion engine, electric, hydraulic or pneumatic motor that generates a torque ripple. It is understood that the primary mover 212 may be a hybrid power source including both an internal combustion engine and an electric motor.

The transmission 214 facilitates driving engagement between the variable inertia flywheel 500 and a ground engaging device (not shown) in a plurality of drive ratios. The transmission 214 may be an automatic transmission, a manual transmission, a continuously variable transmission, or another type of transmission. As known in the art, the transmission 214 may include a clutching device (not shown).

FIG. 3C depicts the variable inertia flywheel 500 shown in FIGS. 3A and 3B, where the position of the roller guide 240 has been adjusted axially to have a torque ripple compensation with lower amplitude as it was the case for FIG. 3A, due to confining the rollers 220 within a smaller radial distance from the central shaft 202.

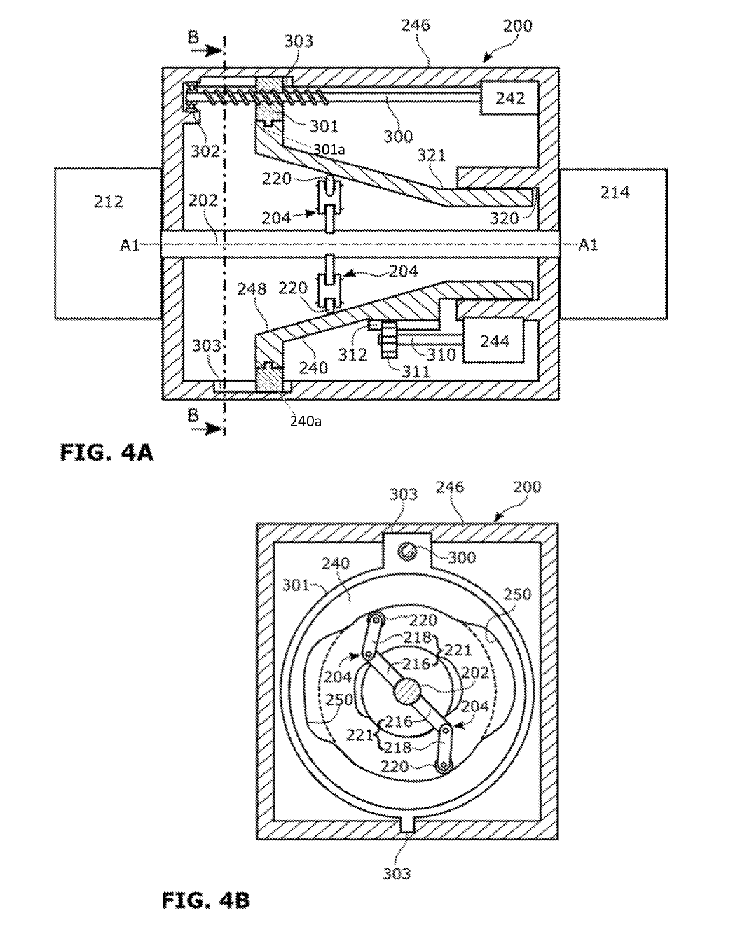

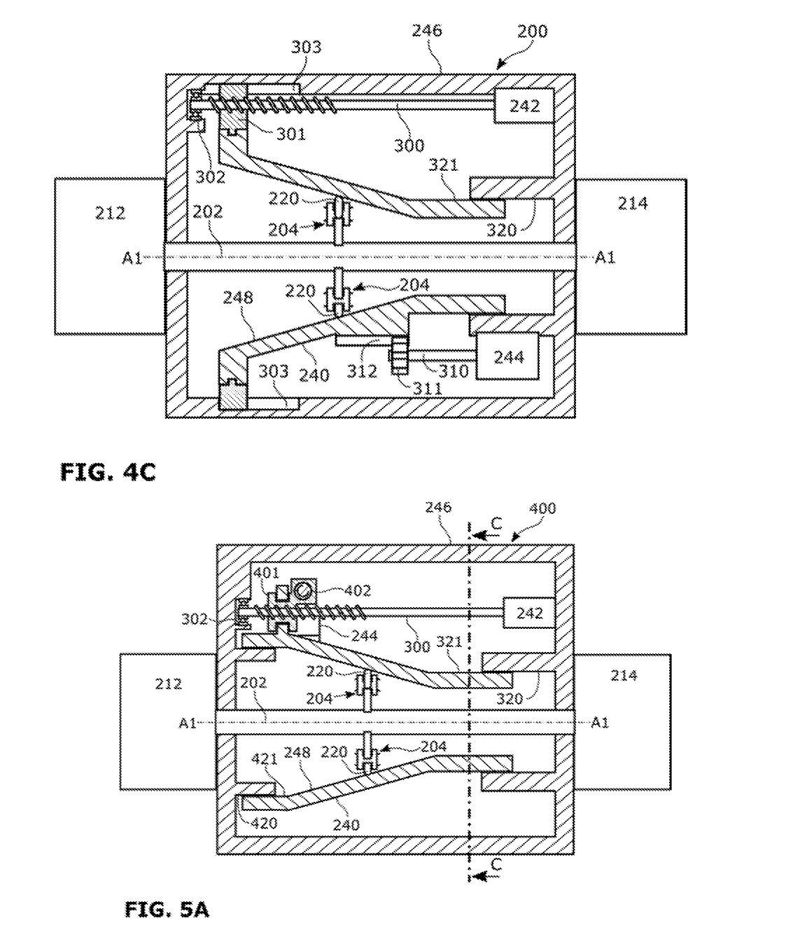

FIGS. 4A-4C depict another preferred embodiment of a variable inertia flywheel 200. The embodiment depicted in FIGS. 4A-4C include similar components to the variable inertia flywheel 500 illustrated in FIGS. 3A-3C. Similar features of the variation shown in FIGS. 4A-4C are numbered similarly in series with the exception of the features described below.

As illustrated in FIGS. 4A-4B, the variable inertia flywheel 200 includes a first lead screw 300 drivingly connected to the first actuator 242 and a ring mover 301. In some embodiments, the variable inertia flywheel includes a bearing 302. The first lead screw 300 can be a lead screw, ball screw or spindle, having a threading or worm gear on the outer surface thereof. In some embodiments, the ring mover 301 has a threaded axial aperture therein which meshingly engages with the threads or gear of the lead screw 300. When the first actuator 242 rotates the spindle or screw 300, the rotational movement of the spindle 300 is translated into axial movement of the ring mover 301 along the first lead screw 300.

It is understood that the threads and/or gears of the lead screw 300 and/or the ring mover 301 can be replaced with similar structures that allow for translation of rotational movement of the lead screw to axial movement of the ring mover 301.

In some embodiments, the first lead screw 300 is radially fixed with a bearing inside the first actuator 242 on one axial end of its active threaded length. On the other axial end, the first lead screw 300 is preferably radially fixed inside a bearing 302 attached to the flywheel housing 246. In some embodiments, the ring mover 301 has a circumferential notch or groove 301a on a radially inner surface of the ring mover 301 facing the central shaft 202. The notch or groove 301a is in sliding engagement with a matching groove or notch 240a on the radially outer surface of the roller guide 240, and forms a sliding surface, that allows only rotational movement between the ring mover 301 and the roller guide 240 around the primary axis A1.

In some embodiments, the ring mover 301 has one or more notches or grooves 303 on the radially outer surface thereof in the direction of the primary axis A1. The grooves are in sliding engagement with corresponding grooves or notches 303 in the housing 246. These grooves 303 restrict the rotational movement of the ring mover 301 around the primary axis A1, but allow sliding axially movement along in the direction of the primary axis A1.

FIG. 4C illustrates the variable inertia flywheel 200 shown in FIGS. 4A and 4B, where the position of the roller guide 240 has been adjusted by the first actuator 242, to have a torque ripple compensation with lower amplitude as it was the case for FIG. 4A, due confining the rollers 220 within a smaller radial distance from the central shaft.

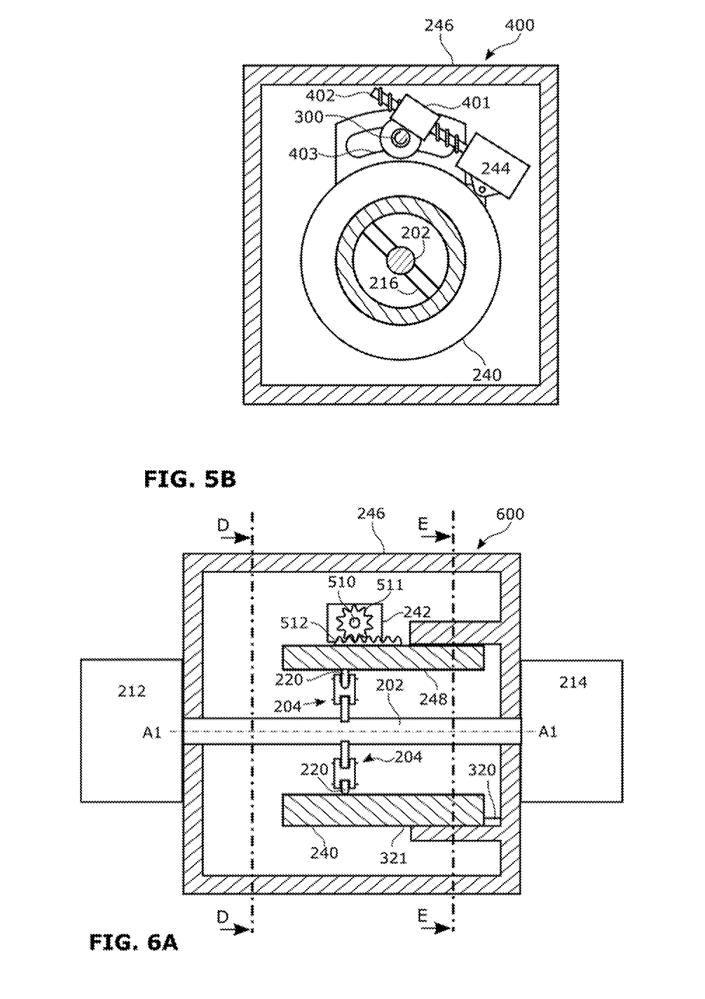

FIGS. 5A and 5B depict another preferred embodiment of a variable inertia flywheel 400. The embodiment depicted in FIGS. 5A-5B include similar components to the variable inertia flywheel 500, 200 illustrated in FIGS. 3A-3C, 4A-4C. Similar features of the variation shown in FIGS. 5A-5B are numbered similarly in series with the exception of the features described below.

As depicted in FIGS. 5A and 5B, the variable inertia flywheel 400 includes a second lead screw 402, a mover insert 401, a third sliding surface 421, a fourth sliding surface 420.

The threaded length of the lead screw 300 is meshingly engaged with a threaded axial aperture in the mover insert 401. In some embodiments, the mover insert 401 is fixed to the roller guide 240. In some embodiments, the mover insert 401 is fixed to a longitudinal arc-shaped hole 403 in the roller guide 240. In some embodiments, the mover insert 401 is fixed to the roller guide 240 by a matching pair of a notch and/or groove, that restricts relative movement of the mover insert 401 and the roller guide 240 towards each other in the direction of the primary axis A1. In some embodiments, the mover insert 401 at the position of fixation to the roller guide is cylindrical to allow the mover insert 401 to rotate around the axis of the first lead screw 300. In some embodiments, the mover insert 401 can slide inside the arc shaped hole 403 in the roller guide 240, providing an orbiting movement around the primary shaft A1.

In some embodiments, the second actuator 244 drives the second lead screw 402. The second lead screw 402 can be a lead screw, ball screw or spindle, having a threading or worm gear on the outer surface thereof. In some embodiments, the mover insert 401 has a second threaded aperture perpendicular to the direction of the primary axis A1 therein which meshingly engages with the threads or gears of the second lead screw 402. When the second actuator 244 rotates the second lead screw 402, the rotational movement of the second lead screw 402 is translated into relative movement between the second actuator 244 and the mover insert 401 along the lead screw 402.

It is understood that the threads and/or gears of the lead screw 402 and/or the mover insert 401 can be replaced with similar structures that allow for translation of rotational movement of the lead screw 402 to axial movement of the mover insert 401.

In some embodiments, the second lead screw 402 is radially fixed by a bearing inside the second actuator 244 on one end of its active threaded length.

The second actuator 244 is rotatably connected to the roller guide 240 at an angular position different from the mover insert 401 such that the first and second actuators 242, 244 are substantially perpendicular to each other. By rotating the second lead screw 402, the angular distance between the second actuator 244 and the mover insert 401 is changed. The angular position of the mover insert 401 with respect to the flywheel housing 246 is fixed due to the fixed angular position of the first lead screw 300. The relative angular position of the second actuator 244 with respect to the roller guide 240 is also fixed. Therefore, the relative movement of the second actuator 244 with respect to the mover insert 401 leads to a rotational movement of the roller guide 240 with respect to the flywheel housing 246.

In some embodiments, the mover insert 401 and the ring mover 301 are one integral part.

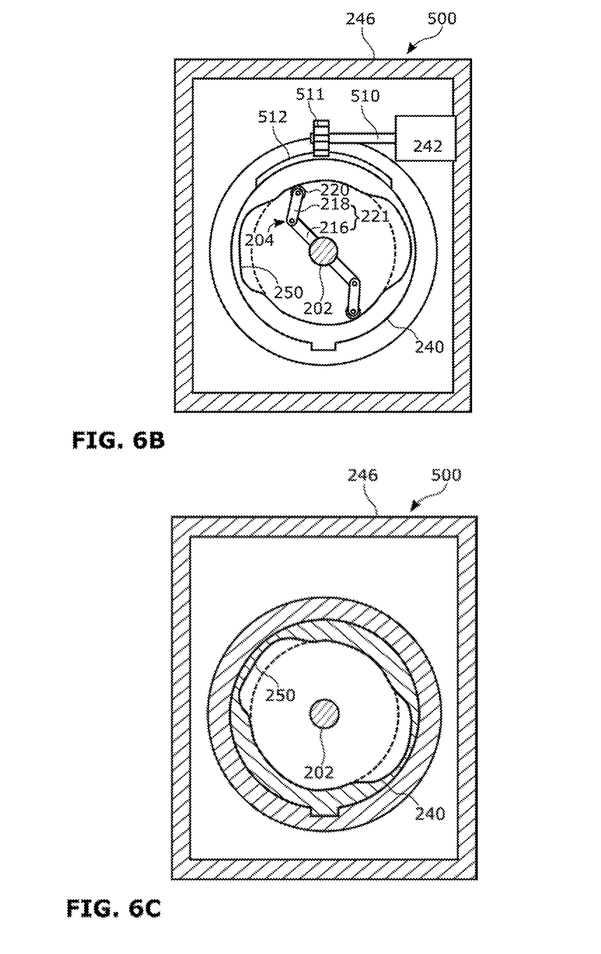

FIGS. 6A-6C depict another preferred embodiment of a variable inertia flywheel 600. The embodiment depicted in FIGS. 6A-6B include similar components to the variable inertia flywheel 500, 200, 400 illustrated in FIGS. 3A-3C, 4A-4C, 5A-5B. Similar features of the variation shown in FIGS. 6A-6B are numbered similarly in series with the exception of the features described below

As depicted in FIGS. 6A-6C, in some embodiments, the roller guide 240 of the variable inertia flywheel 600 is of substantially cylindrical shape and the angular position of the cam profiles 250 on the inner surface of the roller guide 248 varies with respect to the direction of the primary axis A1.

The variation of the angular position can be performed by a helical arrangement of the cam profiles 250, but is not limited to a helical shape. An example for a different cam profile angle can be seen in the two sections indicated in FIG. 6A, see FIGS. 6B and 6C.

In some embodiments, the flywheel includes only one actuator 242 and the roller guide 240 has an axial threaded aperture therein. A lead screw substantially parallel to the primary axis A1 is drivingly engaged with the actuator 242 and has a threaded outer surface meshingly engaged with the threaded aperture of the roller guide 240. The actuator 242 is attached to flywheel housing 320.

In use, the variable inertia flywheel 500, 200, 400, 600 is drivingly engaged with the primary mover 212 through the central shaft 202. The variable inertia flywheel 500, 200, 400, 600 is a parallel, torque additive device for the primary mover 212. By adjusting a position of the roller guide 240, the variable inertia flywheel 500, 200, 400, 600 applies torque to the central shaft 202 to correct a torque ripple generated by the primary mover 212. The variable inertia flywheel 500, 200, 400, 600 allows an amplitude and a phase of a torque generated by the variable inertia flywheel 500, 200, 400, 600 to be adjusted to correct a torque ripple generated by the primary mover 212.

As shown in FIGS. 3A, 3B, 4A, 4B, 5A, 5B, 6A, and 6B, the variable inertia flywheel 500, 200, 400, 600 includes two revolute joint assemblies 221 and two cam profiles 250. The variable inertia flywheel 500, 200, 400, 600 including two revolute joint assemblies 221 and two cam profiles 250 may be used to correct a torque ripple generated by a four-stroke internal combustion engine having four cylinders or by a two stroke internal combustion engine, a hydraulic or pneumatic motor or an expander having two cylinders.

As a first non-limiting example, a variable inertia flywheel according to the invention as described herein including three revolute joint assemblies and three cam profiles may be used to correct a torque ripple generated by a four-stroke internal combustion engine having six cylinders or a two-stroke internal combustion engine, hydraulic or pneumatic motor or expander having three cylinders.

As a second non-limiting example, a variable inertia flywheel according to the invention as described herein including four revolute joint assemblies and four cam profiles may be used to correct a torque ripple generated by a four stroke internal combustion engine having eight cylinders, a two-stroke internal combustion engine, hydraulic or pneumatic motor or expander having four cylinders or the torque ripple generated by an electric engine having two phases and one pole pair.

Generally the number of cam profiles must match the number of cylinders divided by the number of strokes and multiplied by two for engines comprising displacement cylinders and must match the product of the number of phases multiplied with the number of poles for electrical machines.

The equation below descries a relationship between several parameters and its derivatives over time which plays a crucial role in the generation of torque by the variable inertia flywheel 500, 200, 400, 600. The parameters are: an inertia of the revolute joint assemblies 221, a rotational speed of the revolute joint assemblies 221, and a mass of the revolute joint assemblies 221.

$${T}_{gen} = \frac{1}{ω} \frac{{dE}_{kin}}{dt} , {E}_{k i n} = \sum \frac{{m}_{i} {v}_{i}^{2}}{2} + \frac{{J}_{i} {ω}_{i}^{2}}{2}$$

In the equation above T_{gen} is a torque generated by the variable inertia flywheel 500, 200, 400, 600, is a rotational speed of the revolute joint assemblies 221 and Eₖᵢₙ is the kinetic energy of the revolute joint assemblies 221. A varying inertia over time will thus generate a torque on the central shaft 202.

By applying a force to the roller guide 240 using the first actuator 242 to move the roller guide 240 axially along the primary axis A1, an amplitude of a torque generated by the variable inertia flywheel 500, 200, 400, 600 can be adjusted to correct a torque ripple generated by the primary mover 212. The amplitude of a torque generated by the variable inertia flywheel 500, 200, 400, 600 is adjusted by changing a position of the roller guide 240 with respect to the revolute joint assemblies 221.

By moving the roller guide 240 axially along the primary axis A1 while the revolute joint assemblies 221 rotate within the roller guide 240, a radius of the revolute joint assemblies 221 can be controlled. In response to a change of a radius of the revolute joint assemblies 221, an average inertia of the revolute joint assemblies 221 also changes. Adjustment of a position of the roller guide 240 during operation of the primary mover 212 using the controller may highly reduce torque ripples generated by the primary mover 212, without concern for under correction or over correction.

Control of the amplitude of a torque generated by the variable inertia flywheel 500, 200, 400 permits the variable inertia flywheel 500, 200, 400 to generate a higher inertia (through a greater radius of the revolute joint assemblies 221) at lower operating speeds of the primary mover 212 and a lower inertia (through a smaller radius of the revolute joint assemblies 221) at higher operating speeds of the primary mover 212.

In some embodiments, the actuator 242 is in engagement with the revolute joint assemblies 221 and is configured to apply a force to the revolute joint assemblies 221 to move the revolute joint assemblies 221 along the primary axis A1, thereby changing the axial position of the revolute joint assemblies 221, while keeping the axial position of the roller guide 240 fixed, to adjust an amplitude of a torque generated by the variable inertia flywheel 200.

The phase of the torque ripple generated by the primary mover 212 is not constant and varies with an operating speed and a load applied to the primary mover 212. Thus, the phase angle of a torque generated by the variable inertia flywheel 500, 200, 400, 600 needs to be adapted based on such parameters. The phase angle of a torque generated by the variable inertia flywheel 200 can be controlled using two methods.

In a first preferred method of using the variable inertia flywheel 500, 200, 400, a force is applied to the roller guide 240 using the second actuator 244 to rotate the roller guide 240 about the primary axis A1, changing a rotational position of the cam profiles 250 of the roller guide 240 with respect to the central shaft 202.

In a second preferred method of using the variable inertia flywheel 600, an axial position of the roller guide 240 with respect to the revolute joint assemblies 221 in the direction of the primary axis A1 is adjusted. In the second method, the cam profiles 250 are shaped to adjust the phase angle of a torque generated by the variable inertia flywheel 600. By varying the shape of the cam profiles 250 along the radially inner surface 248 of the roller guide 240, a phase angle of a torque generated by the variable inertia flywheel 600 is adjusted as an amplitude in response to a rotational speed of the primary mover 212, using the first actuator 242. It is understood that the arrangement of the cam profiles 250 along the inner surface 248 of the roller guide 240 is designed to adjust a phase angle of a torque generated by the variable inertia flywheel 600. The arrangement can be, but is not limited to, a helical cam profile arrangement. Similarly, it is also understood that of the shape of the cam profiles 250 of the roller guide 240 are designed to adjust a phase angle of a torque generated by the variable inertia flywheel 500, 200, 400 by using the second actuator 244 to rotate the roller guide 240 about the primary axis A1. It is also understood that the first method and the second method may be combined in using the variable inertia flywheels 500, 200, 400, 600.

Based on the foregoing, it can be appreciated that the variable inertia flywheel 500, 200, 400, 600 described and depicted herein has several advantages over the known art. Some of the advantages of the variable inertia flywheel 500, 200, 400, 600 include, but are not limited to, providing a torque ripple compensation that can be actively regulated in an amplitude and a phase. Additionally, the energy consumption of the variable inertia flywheel 500, 200, 400, 600 is not significant, as any losses associated with the operation of the variable inertia flywheel 500, 200, 400, 600 are minor. As described hereinabove, the variable inertia flywheel 500, 200, 400, 600 can be applied for any driving speed of a vehicle incorporating the variable inertia flywheel 500, 200, 400, 600. Accordingly, a driving performance of the vehicle can be maintained, and a torque generated by the variable inertia flywheel 500, 200, 400, 600 can be adjusted based on an operating speed of the primary mover 212.

Additionally, the variable inertia flywheel 500, 200, 400, 600 may be retrofit to existing primary movers or engines to address torque ripple concerns. Further, through use of the variable inertia flywheel 500, 200, 400, 600, a torque ripple generated by the primary mover 212 can be actively cancelled. As a result, an amount of inertia required to reduce an effect of torque ripples can be decreased, which results in an improved driving performance of the vehicle incorporating the variable inertia flywheel 500, 200, 400, 600.

In accordance with the provisions of the patent statutes, the present invention has been described in what is considered to represent its preferred embodiments. However, it should be noted that the invention can be practiced otherwise than as specifically illustrated and described without departing from its spirit or scope.

1. A variable inertia flywheel for a primary mover; the variable inertia flywheel comprising:
a central shaft in driving engagement with the primary mover and a transmission defining a primary axis;
a flywheel housing coupled to the primary mover and the transmission;
at least two revolute joint assemblies in driving engagement with the central shaft, each of the revolute joint assemblies comprising:
a first member coupled to the central shaft,
a second member pivotally coupled to the first member, and
a roller rotatably coupled to the second member;
a roller guide disposed about the revolute joint assemblies and the central shaft, the roller guide having a substantially hollow conical shape and a radially inner surface, wherein the radially inner surface defines at least two cam profiles and is in rolling contact with each of the rollers of the revolute joint assemblies;
a first actuator in engagement with the roller guide; and
a second actuator in engagement with the roller guide,
wherein the second actuator is configured to apply a force to the roller guide to rotate the roller guide about the primary axis, and
wherein the first actuator is configured to apply a force to the roller guide to move the roller guide along the primary axis.

2. The variable inertia flywheel of claim 1, wherein the cam profiles are elongate recesses defined by the inner surface of the roller guide and extend radially outwardly from the inner surface of the roller guide.

3. The variable inertia flywheel according to claim 1, wherein a portion of the radially outer surface of roller guide is in sliding contact with a portion of the flywheel housing.

4. The variable inertia flywheel according to claim 3, wherein the flywheel housing is configured to restrict movement of the roller guide radially.

5. The variable inertia flywheel according to claim 1, further comprising a first actuator shaft substantially perpendicular to the primary axis,
wherein the first actuator is attached to the flywheel housing,
wherein the first actuator shaft is drivingly engaged to the first actuator and a first actuator gear,
wherein the first actuator gear includes a set of teeth meshingly engaged with a plurality of teeth positioned on the radially outer surface of the roller guide, and
wherein the first actuator is configured to apply a force to the roller guide to move the roller guide axially along the primary axis.

6. The variable inertia flywheel according to claim 1, further comprising:
a ring mover having an axial threaded aperture therein; and
a first lead screw substantially parallel to the primary axis drivingly engaged with the first actuator having a threaded outer surface meshingly engaged with the threaded aperture of the ring mover;
wherein the first actuator is attached to the flywheel housing,
wherein the ring mover is movable along the primary axis, wherein the roller guide is connected with the ring mover, such that the roller guide is rotatable around the primary axis, and
wherein the axial position of the roller guide relative to the ring mover is fixed.

7. The variable inertia flywheel according to claim 1, wherein at least one of the first and second actuators is a hydraulic or pneumatic motor.

8. The variable inertia flywheel according to claim 1, wherein at least one of the first and second actuators is a stepper motor or servomotor.

9. The variable inertia flywheel according to claim 1, further comprising a second actuator shaft substantially parallel to the primary axis,
wherein the second actuator is attached to the flywheel housing,
wherein the second actuator shaft is drivingly engaged to the second actuator and a second actuator gear,
wherein the second actuator gear includes a set of teeth meshingly engaged with a plurality of teeth positioned on the radially outer surface of the roller guide, and
wherein the second actuator is configured to apply a tangential force to the roller guide to rotate the roller guide around the primary axis.

10. The variable inertia flywheel according to claim 1, further comprising:
a mover insert having a threaded aperture perpendicular to the primary axis therein; and
a second lead screw substantially perpendicular to the primary axis drivingly engaged with the second actuator and having a threaded outer surface meshingly engaged with the threaded aperture of the mover insert;
wherein the second actuator is attached to the flywheel housing, and
wherein the mover insert is in contact with the roller guide, such that the mover insert controls the rotational position of the roller guide without restricting the axial position of the roller guide.

11. A variable inertia flywheel for a primary mover; the variable inertia flywheel comprising:
a central shaft defining a primary axis and in driving engagement with the primary mover and a transmission;
a flywheel housing coupled to the primary mover and the transmission;
at least two revolute joint assemblies in driving engagement with the central shaft, each of the revolute joint assemblies comprising:
a first member coupled to the central shaft,
a second member pivotally coupled to the first member, and
a roller rotatably coupled to the second member;
a roller guide disposed about the revolute joint assemblies and the central shaft, the roller guide having a substantially hollow cylindrical or conical shape and a radially inner surface, wherein the radially inner surface defines at least two cam profiles and in rolling contact with each of the rollers of the revolute joint assemblies; and
an actuator in engagement with the roller guide,
wherein the actuator is configured to apply a force to the roller guide to move the roller guide along the primary axis, and
wherein the angular position of the cam profiles on the radially inner surface of the roller guide varies with respect to the primary axis.

12. The variable inertia flywheel of claim 11, wherein the cam profiles are elongate recesses defined by the inner surface of the roller guide and extend radially outwardly from the inner surface of the roller guide.

13. The variable inertia flywheel according to claim 11, wherein a portion of the radially outer surface of roller guide is in sliding contact with a portion of the flywheel housing.

14. The variable inertia flywheel according to claim 13, wherein the flywheel housing is configured to restrict movement of the roller guide radially.

15. The variable inertia flywheel according to claim 11, further comprising an actuator shaft substantially perpendicular to the primary axis,
wherein the actuator is attached to the flywheel housing,
wherein the actuator shaft is drivingly engaged to the actuator and an actuator gear,
wherein the actuator gear includes a set of teeth meshingly engaged with a plurality of teeth positioned on the radially outer surface of the roller guide, and
wherein the actuator is configured to apply a force to the roller guide to move the roller guide axially.

16. The variable inertia flywheel according to claim 11, further comprising:
a lead screw substantially parallel to the primary axis drivingly engaged with the actuator having a threaded outer surface,
wherein the roller guide has an axial threaded aperture therein,
wherein the threaded outer surface of the lead screw is meshingly engaged with the threaded aperture of the roller guide, and
wherein the actuator is attached to the flywheel housing.

17. The variable inertia flywheel according to claim 11, wherein the actuator is a hydraulic or pneumatic motor.

18. The variable inertia flywheel according to claim 11, wherein the actuator is a stepper motor or servomotor.

19. The variable inertia flywheel according to claim 1, further comprising:
a mover insert having a threaded aperture perpendicular to the primary axis therein; and
a second lead screw substantially perpendicular to the primary axis drivingly engaged with the second actuator and having a threaded outer surface meshingly engaged with the threaded aperture of the mover insert;
wherein the second actuator is attached to the roller guide, and
wherein the mover insert is in contact with a portion of the flywheel housing or a first actuator shaft that is aligned parallel to the primary axis.

20. The variable inertia flywheel according to claim 1, wherein the primary mover is a four-stroke internal combustion engine.
